(19) United States
(12) Patent Application Publication
(10) Pub. No.: US 2026/0336539 A1
(43) Pub. Date: Oct. 29, 2026

(54) A METHOD OF OPERATING A COORDINATOR SYSTEM, COORDINATOR SYSTEM, AND A VEHICLE WITH THE SAME

(71) Applicant: AUDI AG, Ingolstadt (DE)

(72) Inventor: John NEWMAN, Ingolstadt (DE)

(73) Assignee: AUDI AG, Ingolstadt (DE)

(21) Appl. No.: 19/099,109

(22) PCT Filed: Oct. 19, 2022
(86) PCT No.: PCT/EP2022/079043

§ 371 Date: Jan. 28, 2025

(51) Int. Cl. B60R 16/023

(52) U.S. Cl. CPC B60R 16/0231

(57) ABSTRACT

A method of operating a coordinator system being coupled to multiple input devices and multiple actuators. From at least one input device data defining a situation to be created by the actuators are received, and in reaction to such receipt, at least one actuator is selected, and signals are generated/output to the selected at least one actuator.

### FIELD

The invention is concerned with a method of operating a coordinator system for a vehicle, with a coordinator system able to perform the method, and with a vehicle including such coordinator system.

The general field of the invention is related to offering products and services, for persons in a vehicle, by third parties, the third parties being different from persons in the vehicle and different from the vehicle manufacturer. The invention is however not limited to such applications and is generally suited to provide a system and method for customizing a vehicle function. The vehicle function does need not to be related to products or services.

### BACKGROUND

In the field of advertising, US2008/288406 A1 discloses tracking the travel patterns of a vehicle, i.e., by means of the global positioning system, GPS, and to aggregate further data of the user of the vehicle such as from his or her personal computer system or other access systems for the internet. A temporal dependency of the travel patterns might be as well recorded. Hence, dependent on where the user travels and when he/she does so, promotional offers are delivered to the user in the vehicle. The device for delivering the offers is as such well defined in advance. One might imagine providing images on a screen, head-up display, and the like.

DE 10 2018 200 470 A1 teaches to provide specific information such as advertisement to a user in a vehicle if specific data provided in or by the vehicle fulfill a predetermined criterion. The output system is assumed to be predetermined as well.

From US 2017/0129426 A1, it is known to include the output of sensors in an automobile to detect usage events. Depending on such events, recommendations as to goods, services, information are suggested. For instance, the user might be recommended to change his or her seat position, access third party applications, and the like. The output systems are here dependent on the recommendation and thus predetermined.

A general tendency is that third parties have an increased desire to obtain some access to output systems (actuators) in a vehicle, whilst at the same time of course, other criteria such as safety, regulations, and aesthetic rules should be respected as well. A specific kind of platform would be desirable.

### SUMMARY

It is an object of the present invention to provide a method of operating a coordinator system for a vehicle that is more flexible, to provide a suitable coordinator system, and a vehicle with such coordinator system.

Accordingly, the object is solved by a method of operating a coordinator system for a vehicle, the coordinator system being coupled to multiple input devices and being able to receive data from each of the input devices, and the coordinator system being coupled to multiple actuators of the vehicle and being able to output control signals to each actuator. The invention provides the steps of:
Receiving, by the coordinator system, via at least one input device, data that define a situation to be created by means of the actuators. (The data might be provided in a predetermined language.);
selecting, by the coordinator system, in reaction to the receipt of the data, at least one actuator; and
generating and outputting control signals to the selected at least one actuator.

The invention provides a flexible method by letting the coordinator system select the actuators in dependence of the situation to be created. Whilst hitherto known systems use algorithms according to which the actuators are already predetermined for a specific situation, the coordinator system may here have wide opportunities going far beyond of a simple input-output relationship. Specifically, if the coordinator system includes means to provide artificial intelligence, such as neural networks, in particular convolutional neural networks, the coordinator system might be self-learning and able to adapt to the habits and preferences of the user of the vehicle. The coordinator system might be able to understand a standard non-computer language (natural language), such as English, German, French, and the like, and will then “translate” the data provided in such predetermined language into control signals to actuators, wherein these actuators are selected dependent on the contents provided in the predetermined language (namely on the situation to be created). The provider of the vehicle is the only party that has to define the coordinator system, by programming and/or by teaching for machine-learning, whilst other parties do not need to adapt: Neither the company that provides actuators has to be involved in defining the coordinator system, nor third parties that desire to give input content and/or input orders.

The invention may anticipate the opportunity to advertise products and services to customers, either directly relevant to existing purchases, or substitutes, complements, or adjacencies. For example, the choice of a customer to purchase and display a high-quality photograph on or more vehicle display screens, could lead to offers to purchase a physical print of the photograph, tickets for a photography exhibit, and so on. This concept may generally be extensible to other products (such as car rims and car wraps), and services, such as the installation of vehicle parts. Moreover, as more, and more complex, content is provided by third parties to customers, there is a need to “orchestrate” the presentation of such content so that it does not create aesthetic, safety or regulatory challenges. The invention provides a mechanism whereby the state and performance characteristics of low-level actuators within a vehicle may be defined, and such information is known, in aggregate across many actuators, and algorithms within the coordinator system (the “orchestrator”) are used then to prioritize between different competing, or even conflicting, demands for the actuators (with safety-critical requirements having the highest priority), and then, for a legitimate application seeking to use multiple actuators to deliver an experience to individuals (such as the concomitant changing of seat position, air conditioning speed and temperature, interior and exterior lighting, etc.), the coordinator system establishes the ability of relevant actuators to accept commands, establishes a starting reference point, executes the desired application (while “listening” for signals that would terminate the application), and then exits the application routine and restores actuator settings to initial values (or values to prepare for the execution of a follow-on application).

The invention also comprises embodiments that provide features which afford additional technical advantages.

In a preferred embodiment of the invention, the data defining a situation to be created have the function of meta data that are received by the coordinator system together with content data, wherein the content data are able to be used to directly define control signals for one or more predetermined actuators. An example of content data are images or audio signals that are directly transferrable into control signals for a screen, or for a microfilm. The coordinator system, in the embodiment, outputs the control signals to the selected one or more actuators in a coordinated manner, in conjunction with outputting the control signals to the one or more predetermined actuators.

The meta data thus are able to describe a situation to be created that is as well in some manner described in the content data or created by the latter when these are used (displayed, output, . . . ).

In the example of the content data being video data, the actuators might be driven in a manner so as to complement what is happening in the video data. To give a specific example, in a movie where there is snow falling and cold wind blowing, the meta data might simply include the word “cold” (or in German: “kalt”, in French: “froid”, and the like) and to create a suitable situation, the air conditioning of the vehicle will turn to cold temperatures. The user in the vehicle is thus getting the physical impression of the snow and the cold wind in the movie. For third parties such as those who offer videos, it is most easy to have a few meta data added and transferred together with the content data, the video data. The advantage is that a user in a vehicle has a perfect event created. The same may apply to audio signals with additional meta data. The meta data may, however, as well be extractable from the content data. In a most simple version thereof, the audio data include an indication as to when the meta data are provided, or by whom. For instance, there might be a “speaker” in the movie who comments on the situation when there is a change. Only from the comments of the speaker, the meta data might be extracted, wherein what other persons in the movie are speaking might be disregarded. (Of course, future artificial intelligence systems might be able to deduce much more complex meta data from content data).

According to a preferred embodiment, the coordinator system generates and outputs two sequential different control signals for one of the at least one selected actuators, thereby creating a situation changing over time.

This embodiment has the advantage that static content (e.g., the personalization of vehicle interiors with custom images and specific LED (light-emitting diode) configurations), can be extended to result in the sequential display of images, with image selection to be determined by temporal, spatial, vehicular (speed, status), behavioral (as to passenger or occupant; mood, tactile, voice, facial, motion input), or event-based cues (such as sporting events, news, weather, etc.). The concept is not restricted to images or LED configurations but might apply to all vehicle electrical control units (ECUs) and actuators that can be safely adjusted.

In another preferred embodiment, the coordinator system receives the data by a single input device, selects at least two actuators and generates signals for the at least two actuators, thereby defining a scenery.

Such embodiment is a more complex one. The two actuators might be of the same type (such as lamps, together defining an illumination scenery) or might be of two different kinds. For instance, if in a movie—assuming that there is the embodiment discussed above provided at the same time—, the keyword is “warm”, as received as (meta-)data via the single input device, any actuator relating to the light temperature might play a role. Namely, those actuators might be activated that emit rather red or at least yellow light, whilst actuators that emit blue or white light are less likely to be activated in the situation defined as “warm”.

In an alternative to the embodiment, the coordinator system receives data by multiple input devices, the data defining together the situation to be created. For instance, a seat occupancy sensor as an input device might first be able to detect whether or not a child safety seat is mounted in the vehicle and another sensor device might be able to detect whether the child seat is occupied. Then, the situation to be created might be “children's theme”, for instance a specific color and pattern suited for the children might be used. The child sitting in the child seat might be provided specific images suited for children, children's movies, and the like.

In a preferred embodiment thereof, the coordinator system selects at least two actuators and generates and outputs signals for the at least two actuators, thereby defining the situation as a scenery. The combination of multiple input devices and multiple actuators might here be advantageous. The invention might be able to control between 40 and 200 actuators, for example, and there might of course be situations where the data defining together the situation to be created, for multiple input devices, might trigger with the coordinator system the selection of more than a single actuator.

The combination of multiple input devices and a single actuator however, might as well occur with one and the same coordinator system, depending on the situation defined to be created.

In another preferred embodiment of the invention, the coordinator system receives data by an input device provided separately to the vehicle. Here, an interface to the “outside world” is given, wherein the input device might here be transportable, even into the vehicle, such as a mobile telephone, smartphone, a smartwatch, a notepad, a notebook, and the like. The input device might however as well be completely external to the vehicle, the vehicle then only including a receiving means for the data defining the situation to be created.

In another embodiment, the coordinator system receives data by at least one sensor of the vehicle. For instance, the sensor might inform about the physical wear status of car parts to create opportunities for third parties to enter into commercial transactions with vehicle owners (whether individuals or fleets). One example would include the offer of remanufacturing services for parts nearing the end of their useful life. An interesting option would be to offer new, used (but functional), or higher performance parts to the user, on such platform.

The sensor of the vehicle might further define a situation to be created together with input data from other sensors. For instance, a temperature sensor might play a role in defining a scenery: Depending on the temperature, the user might be shown other images on a screen than at lower temperatures. (For instance: the user might obtain information that an ice-cream parlor is close if there are high temperatures, and on the other hand might be informed about a diner restaurant when there are lower temperatures outside. The sensors might as well sense a time of travel and inform after some time of travel the user via images or other output on the presence of washing rooms/toilets on the pathway. Another sensor might sense the amount of fuel remaining or, in an electric vehicle, the percentage of charge of the battery, and the user might be informed via optical or acoustical output, or other output (haptic, and the like) about petrol stations/charging stations on the pathway.

In another embodiment, the coordinator system receives data by at least one input device of the vehicle via which a user of the vehicle is enabled to define situations. In particular, human-machine interfaces (screen coupled with a knob; touchscreen; voice recognition) might enable the user to select between a plurality of predefined situations, or to even input a completely new description of a situation. In the case that the coordinator system includes artificial intelligence with word recognition, via the input device of the vehicle, the user might then comment a situation and tell the system his or her desires how to change the situations (“too cold”, “no ice-cream parlor desired”, “want to buy beverages”, and the like).

According to an aspect of the invention, accordingly the coordinator system is provided that it is able to be coupled to multiple input devices and to multiple actuators, the coordinator system configured to select at least one of the actuators, in reaction to it receiving the data that define a situation to be created by means of the actuators, and to generate and to output control signals for creating the situation defined by the data.

The advantages of the inventive method are as well advantages of the coordinator system. As mentioned earlier, a preferred embodiment is that the coordinator system includes means to provide artificial intelligence, such as (convolutional) neural networks.

According to a further aspect of the invention, a vehicle with multiple sensors and multiple actuators is provided, and is characterized by the inventive coordinator system.

The advantages of the method and of the coordinator system are as well found with the vehicle.

For use cases or use situations which may arise in the method and which are not explicitly described here, it may be provided that, in accordance with the method, an error message and/or a prompt for user feedback is output and/or a default settings and/or a predetermined initial state is set.

### BRIEF DESCRIPTION OF THE FIGURES

In the following an exemplary implementation of the invention is described. The figures show:

FIG. 1 a schematic illustration of the interplay between input devices and output devices for and in a vehicle according to the prior art;

FIG. 2 a schematic illustration of the interplay between input device and output devices according to a first embodiment of the invention;

FIG. 3 a schematic illustration of the interplay between input device and output devices according to a second embodiment of the invention;

FIG. 4 a schematic illustration of the interplay between input device and output devices according to a third embodiment of the invention;

FIG. 5 a schematic illustration of another embodiment of the inventive motor vehicle with multiple sensors and an internal user input device;

FIG. 6 a schematic illustration of an embodiment of the inventive motor vehicle with an external input device that provides content data and meta data;

FIG. 7 a schematic illustration of the provision of an NFT when an external input device is used; and

FIG. 8 a schematic illustration of an embodiment of two inventive motor vehicles, illustrating data transfer from a first vehicle to a second vehicle.

### DETAILED DESCRIPTION

The embodiment explained in the following is a preferred embodiment of the invention. However, in the embodiment, the described components of the embodiment each represent individual features of the invention which are to be considered independently of each other and which each develop the invention also independently of each other and thereby are also to be regarded as a component of the invention in individual manner or in another than the shown combination. Furthermore, the described embodiment can also be supplemented by further features of the invention already described.

In the figures identical reference signs indicate elements that provide the same function.

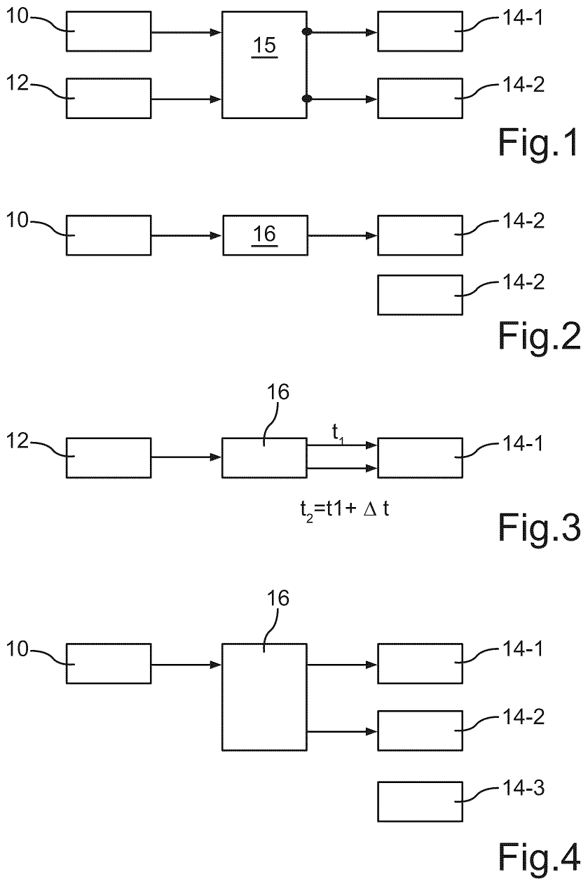

FIG. 1 shows a prior art system: In the prior art, a vehicle is equipped with a sensor 10 as a first input device and an input device 12 different from a sensor, such as an input device that provides a human-machine interface. There are actuators 14-1, 14-2 as output devices. A control unit 15 receives signals from the sensors 10 and the further input device 12 and outputs control signals to the output devices 14-1, 14-2. The depiction is only schematic, wherein with real systems, there are multiple and specifically numerous sensors and further input devices, and there are as well multiple actuators. The relationship between the input signals from the sensor 10 and the input device 12 to the control signals sent by the control unit 15 is deterministic in the prior art. For instance, a user might activate by means of the input device 12 the air condition equipment, and a temperature sensor as the sensor 10 might measure the temperature. Then, the control unit 15 makes use of a predetermined algorithm that determines the output signals to the actuators 14-1, 14-2. Of course, then, it is in advance clear which output devices are activated if specific input signals are provided. The actuators 14-1 and 14-2 might both complement each other in an air condition system, for instance, the first actuator 14-1 might be an electromotor for opening a window of the vehicle, and the second actuator 14-2 might blow cold air. Alternatively, the actuators 14-1 and 14-2 might rely to two different streams of air in one and the same air-conditioning system.

The invention now starts from the idea that multiple input devices and multiple output devices might have an interplay that is not in any aspect foreseeable by those who provide an algorithm for a control unit 15. Hence, the invention paves the pathway for more flexible use of actuators, depending on input signals by sensors 10 and via other input devices 12.

FIG. 2 shows this in a simplified way:

A user might provide via input device 12 data defining a situation to be created by means of the actuators. This might be in a predetermined language, such as English, German, French, and the like (i.e. a natural language). For instance, the user might input via an alphanumerical display (possibly being aided by an autocorrection algorithm complementing words before they have been fully input), a word such as “cooling”. In the invention, there is no longer a control unit 15 such as with the prior art, but rather there is a coordinator system that is more complex than a simple control unit. The coordinator system is specifically preferably embodied by means for providing artificial intelligence, such as by a convolutional neural network, the latter having been trained, e.g. by the user of the vehicle itself.

The invention now lets the coordinator system 16 decide, depending on the input, which actuator to activate. In the example of FIG. 2, for instance, actuator 14-1 is activated whilst actuator 14-2 is not activated. This might be illustrated by the example of a user inserting the word “cooler”, wherein the coordinator system is equipped with language skills including word recognition, phrase recognition, sentence recognition, grammatical skills, and the like. The coordinator system does “translate” the input by the user into at least one control signal for an output device, whereas the output device is selected, i.e. suitably chosen, to fulfill the user's desire, i.e. to create the situation defined by the data input by the user. In the above example of cooling, the coordinator system might have been trained by the user to open the windows, i.e. the actuator 14-1 is then activated, the actuator 14-1 here being an electromotor for driving the windows down. In contrast, an actuator 14-2 responsible for blowing cold air into the vehicle is not activated. It might be that the coordinator system has been learned, upon training by a different user, who dislikes open windows, to blow cold air into the vehicle's passenger cabin. Then, instead of the situation in FIG. 2 with the arrow going from the coordinator system 16 to the actuator 14-1, the arrow will go to actuator 14-2 and not to 14-1.

The invention is not limited to the input system being used by the user (driver, or other passenger) in the vehicle. There might also be external input means allowing third parties to provide control signals in the vehicle. The invention is particularly suited for such applications.

FIGS. 3 and 4 show embodiments wherein on the basis of a single input, multiple outputs are given. FIG. 3 shows the example of two different outputs given to the same actuator 14-1, whilst FIG. 4 illustrates the situation of two actuators 14-1 and 14-2 each receiving an output. Whilst FIG. 3 depicts the input device 12 different from a sensor, FIG. 4 shows a sensor 10 as an input device. However, in FIG. 3 there might be a sensor 10 as an input device, and in FIG. 4 there might as well be an input device 12 different from a sensor 10 used.

According to FIG. 3, a single input signal 12 is received by an input device, and respective data are sent to the coordinator system 16. The latter then sends a control signal to actuator 14-1 at point in time t₁, and sends a second control signal at point t₂, with a time delay of Δt.

In this aspect, the invention provides changing sceneries of what the actuator 14-1 does (and what other actuators might do). For instance, there might be the input “entertainment” via the input device 12, and the coordinator system might provide an actuator such as an LED (light-emitting diode) with control signals to change its color over time. Likewise, the coordinator system might change the image displayed on a screen as the actuator 14-1 over time. This aspect is not limited to providing only two control signals, but this is rather the minimum for this time-changing behavior. There might as well be a further control signal at point t₃=t₂+Δt=t₁+2Δt, or t₃ might be at a point in time with a different time delay Δt₂ from t₂, and so on. Hence, there might be not only two sequential control signals, but also three, four, five, and so forth. The desire is here to change a situation to be created over time, i.e. to provide a changing scenery. The invention might as well relate to a change in time over time-dependent behavior of the actuator 14-1. For instance, there might be LEDs that are blinking. Then, the first signal at t₁ controls the actuator 14-1 to cause the blinking with the first frequency, and at t₂ causes the blinking with a second frequency. Hence, there might be a sub-program running in the actuator 14-1, and the two sequential different control signals might relate each to select the specific sub-program, or to provide a different input parameter for the sub-program. The situation to be created might as well include showing a small movie of some seconds length. The change of the situation over time will then include changing the entire movie. Hence, the data defining the situation to be created in a predetermined language saying “entertainment” leads to a change in the videos.

FIG. 4 illustrates the situation that a single sensor 10 inputs signals to the coordinator system as the (input) data, and the coordinator system then outputs control signals to two different actuators 14-1, 14-2. For instance, the sensor 10 might relate to a system tracking the position of the vehicle, such as the GPS (global positioning system). When the vehicle arrives at a certain position on the road, this may trigger the output of information informing the vehicle driver and the further passengers about a nearby restaurant, and the like. A first actuator 14-1 might then provide a display “restaurant ‘name’ in two kilometers”, and the second actuator 14-2 might be an acoustic output such as a melody or other signal guiding the driver's attention to the display.

The invention is here not limited to the single sensor 10, but there might as well be multiple sensors 10 or combination of sensors 10 and input units 12 that together provide the data defining the situation to be created.

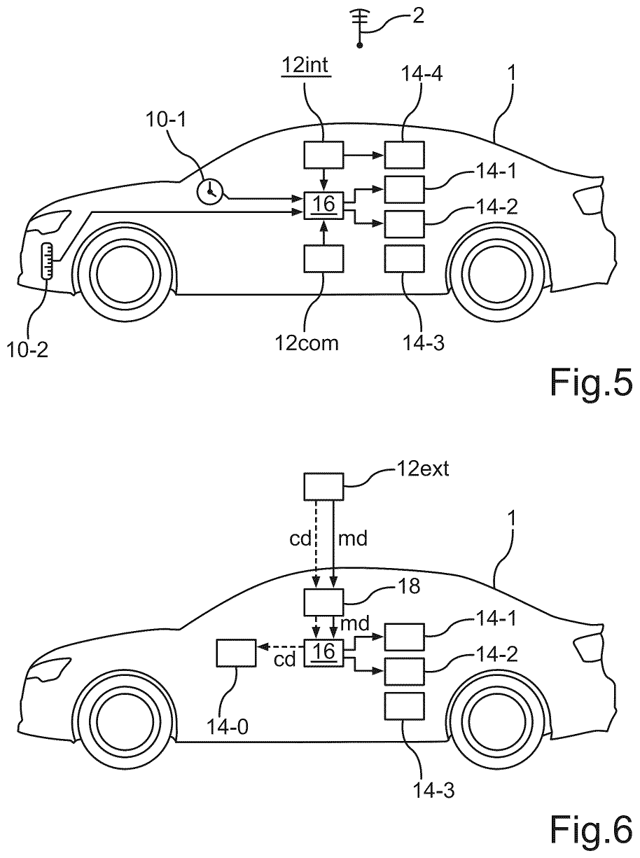

FIG. 5 illustrates an example of such embodiment: Here, in an exemplary way, a first sensor 10-1 is a clock, and a second sensor 10-2 is a thermometer (temperature-sensing device). A third input device is an internal human-machine input device 12int. Via the latter, the driver of the vehicle or another passenger might input how he or she would like to have the temperature in the passenger cabin of the vehicle 1 defined. For instance, via the input means 12int, the user might input “comfortable for two hours” when the trip needs two hours. Then, the clock 10-1 informs about the time of day and the temperature-sensing sensor 10-2 informs about the actual temperature. The coordinator system will thus be able to plan heating or cooling of the passenger cabin for two hours. In the example of relatively early morning and of the environment being already nearly as hot as a comfortable temperature would be in the passenger cabin, the coordinator system might decide that initially, no heating will take place since it is to be reckoned with that later-on the vehicle cabin needs to be cooled, anyhow. The coordinator system 16 thus determines that actuators 14-1, 14-2 for cooling down will be activated, whilst actuator 14-3 for heating will not be activated. In another example, the system might as well include the information provided by a weather forecast, such as obtained by a computer 12com in or of the vehicle that is wirelessly coupled to a satellite 2 that provides internet access. The coordinator system thus, as a further input, receives the weather forecast and may thus plan the activity of actuators and inactivity of other actuators, i.e. may select the actuators, depending on the data received.

The coordinator system, having such role of receiving input by multiple units and of controlling multiple actuators, might as well be called an “orchestrator”. This role might as well include deciding on which actuators to activate/address, and how to do so, in the case of conflicting inputs. For instance, the system might receive input that normally would cause a seat to be moved forward, but the coordinator system might at the same time be coupled to a storage means or a detecting means that informs that the person sitting on the seat is rather tall. The coordinator system will then not move the seat, or only move it to a lesser extent. A conflicting situation might as well include that the vehicle is known by the coordinator system (or detected) to be in motion, whilst there is input demanding to do something that would be distracting the driver. Then, the coordinator system might decide not to follow the demand, or to cause something intermediate to be done. A conflict might furthermore occur when there is a demand to increase the temperature, when at the same time the ambient temperature is already high or a person in the vehicle is detected to be uncomfortable.

The invention does not exclude direct inputs.

In the example of FIG. 5, via the internal input units 12, an actuator 14-4 might be directly controlled in addition to the coordinator system controlling actuators 14-1, 14-2.

FIG. 6 illustrates the situation of a vehicle 1 receiving data from an external input unit 12ext, which may specifically be located outside of the vehicle, sending content data cd and meta data md to the vehicle 1. The data are received by a receiver 18. The content data are without any specific action sent via the coordinator system 16 to an output unit 14-0. The content data might for instance be data providing video and audio of a movie, and the actuator 14-0 might be a screen with a loudspeaker outputting such content data. The meta data md sent together with the content data are those data referred to earlier as the data received by the coordinator system 16. They are here sent via the receiver 18 to the coordinator system 16 that then “translates” the meta data in order to decide which actuators 14-1 and 14-2 to activate, and which actuator 14-3 not to activate, and to define and output the control signals for these. In the case of the movie, there might be a situation where it is cold, the meta data md may say “cold” in English language, or by other means. The first actuator 14-1 may then be activated providing the air conditioning to cool down the passenger cabin. A second actuator 14-2 might relate to the LEDs illuminating the vehicle interior. The coordinator system might translate the term “cool” into activating blue LEDs, whilst disactivating red LEDs.

There are numerous other examples at hand of actuators that may be playing a role in defining a scenery in a more complex way.

The invention has many innovative aspects. For example, a manner how to define content displayed in the vehicle might change: Single images can be slightly moving, or multiple images can be displayed in the slide show. One might use events from external sources to trigger product actions. Such external events could be date, time, locations and other events like weather situations or sport events (victory by a national athlete team, and the like). There might be the use of internal image triggers or wherein events generated from sensors or systems in a vehicle trigger actions. Such events could be generated by the user (e.g. by touching a button, a touch screen, or the like, or by providing voice input). Events could as well be generated by the vehicle (passenger detection for example). Moreover, the driver safety could be improved by adding additional features: Events are then triggered by vehicle warning and in order to secure a safe trip. The image selection might be changed by adding functionalities for customers to select such images: The display and selection of bought images in-app (via an application on a mobile device such as a smart phone or the like, where a specific selection is made), or in-car might take place.

The image location might change: The differentiation of image displays across available screens in the vehicle might take place, each screen representing an actuator such as 14-1, 14-2 in the above figures, and several different displays in the vehicle might provide a single or combined solution, i.e. define a situation to be created.

Images might be manipulated by extending options to which customers can customize images. There might be the application of a basic filter or the creation of slide shows and playlists. Still further, as to the item “image control”, the options may be extended to which customers can sequence images. A manual control can take place as to which images should be displayed. The system might learn preferences of a specific user. There might still further be the use of a gallery to offer new images to the customer, using categorized image feeds to simplify selections.

The ambient lighting features might be evolved. Different lights in the vehicle might represent actuators such as 14-1, 14-2 and the like in the figures above, and this might be combined with manual direct light control.

There might furthermore additional in-vehicle services included in products. For example, the navigation system and climate control might enhance pro-ducts. (In the example of the navigation systems, a product might include providing the navigation system with a target to lead the vehicle driver to.)

There might be a variety of payment mechanisms offered, from single sales to pre-defined packages.

Matchmaking with innovations might furthermore be improved. For instance, vehicle parts might be changed, wherein the new parts have additional functionalities. The coordinator system might then be able to better reckon with such situation than if a simple control unit was used. Additional functionalities could further be to display selective context (e.g. top-x-images) improved.

As to the item “community and sharing”, it is to be noted that sales could be driven via sharing options. The use of a sharing option between customer (e.g., share button) and between owned vehicles could be enhanced. For instance, the system MyAudi® allows a user to share inputs and the resulting outputs between multiple vehicles. This aspect will be illustrated further with respect to FIG. 8 below.

The use of non-mass products and services for unique interior design might result in an exclusive and limited offering for a selected customer group.

Two vehicles having a different manufacture might increase the set of vehicles to offer new products.

The following actuators might play a role in conjunction with the invention, and might specifically be driven by the coordinator system 16 as shown in the figures, and beyond.

A first actuator might relate to the driving profile: These profiles store driving mode and car settings according to driver's preferences. A use case might be the driver's favorite images are shown, the seat and lighting adjusted according to individual preferences. This has the benefit of seamless adaptation of the car to the driving individual, and allows for personalized product offerings depending on the driver.

The contour light as a further actuator provides for adjustment lighting of contours for in-car experience and is accessible by third party creators. Such contour lighting might be adjusted according to an image or movie shown in the vehicle's infotainment system. There might thus be a seamless adaptation of the car to the driving individual, and addition of direct visual lighting to in-car experience.

The surface light as an actuator provides for adjustable lighting of surfaces for in-car experience and is as well accessible by third party creators. Here as well, the surface lighting might be adjusted to the image or movie shown, with the same benefits as with the contour light.

There might furthermore be a communication light involved.

The seat position is made adjustable and accessible for third party creators. An in-car experience for relaxing purposes adjusts seat position by lowering the back of the chair, according to an example. This as well adapts the car to the driving individual, and further adds adjustable seat positions to in-car experience.

The seat massage actuators might as well be adjustable by third party creators, serving for an in-car experience for relaxing purposes by a relaxing back massage, with the benefit of adding adjustable seat positions to in-car experience.

The seat heating might likewise be adjusted by third party creators, e.g. for napping purposes that starts lightly heating the seat at the start and slightly cooling the seat at the end of the napping period. Hence, the adjustable seat temperature is added to the in-car experience.

The sun-roof actuators might be used to open and close the sunroof by third party creators: The cocooning in-car experience closes the sunroof for comfortable setting. Cinema experience closes the sunroof at the start and opens the sunroof at the end of the movie, i.e. the controllable sunroof to in-car experience is added.

As mentioned above, windows and actuators for opening and closing same might as well play a role.

Likewise, window shades might be used to be opened and closed by third party creators. Cocooning in-car experience uses the window shades, and as with the case of the sunroof, the cinema experience closes the shades at the start and opens the shades at the end of the movie, thereby adding control over the window shades to in-car experience.

The actuators for the air temperature, fan speeds, air circulation mode might all and each be controlled by third party creators. An in-car experience for napping purposes starts slightly rising the temperature at the start and slightly lowering the temperature at the end of the napping period, the fan speed is lowered during the napping period, and for napping period the air circulation is intensified at the end of the napping period. This adds controllable air temperature, fan speed and air circulation modes to the in-car experience.

The steering wheel heating actuators might still further be accessible by third party creators and used for in-car experience. An external trigger of low outside temperature activates the steering wheel heating according to the driver's experiences, such that a seamless adaptation of the car to the driving individual is provided and the steering wheel is added to the in-car experience. Likewise, ionization might be provided, e.g., for the purpose of sterilizing car parts, and the like.

Interior scents may be spread according to in-car experience by respective actuators being activated in response to data received by third party creators. For example, as an in-car experience for napping purposes, the vehicle starts spreading freshly washed blanket aroma at the start of the napping period, thereby adding interior scents to the in-car experience.

The central lock actuators might likewise be controlled.

The light signature, e.g. the control of front and rear lights might be used to create patterns and show game situations. Personalization, gaming, video playback, safety (if light is projected on the road) are use cases, leading to better entertainment, and to enhance the safety.

The exterior sound might be controlled in appropriate settings, for example with the purpose to let someone know when it is safe to cross in front of a car, greet other drivers and/or passengers, and inform people about the car status (e.g. too hot, wait x seconds for cooling). This adds an increased ability to communicate with people outside the car.

The media sound playback might be provided by third party creators, for instance to play a relaxing background music for relaxing purpose as an in-car experience, thereby adding media sounds to in-car experience.

Further actuators such as to adaptive music playback, notification sound playback, sound settings, instrument cluster layout, might enhance the in-car experience. The playback of music may adapt to events and experiences, and might be triggered by events. The setting of playback sound can be adjusted by third party creators. An in-car experience for napping purposes plays relaxing music at the start and calm but energizing music at the end of the napping period, a warning sound might be played after external trigger warning of danger ahead, and an artist can set an equalizer to best performance in dependence to the provided songs. This adds adaptive music playback, notification sound playback and sound settings to the in-car experience.

The dimmer mode provides for an adjustable lighting intensity for in-car experience and is accessible by third party creators. For example, during a nap, the intensity of the car's lighting might be reduced, thereby adding dimmer modes to the in-car experience.

There might be a horizon design displayed on an information display in accordance with the real surrounding. In a specific example, the front information device shows the skyline of New York City upon being within five miles of entering the city, therefore seamlessly adapting the car to the real surrounding.

There might be further the so-called ego car actuator that provides a display of the ego car design on the forward information display in accordance within surroundings. In an example, the ego FID (driver information display, or instrument cluster) shows the car in the streets of New York City upon entering the city, and might display the flying superman, thereby seamlessly adapting the car to the real surroundings, and allowing for further product offerings.

An app, external app, launcher app, might be defined via a tile on the display.

An image in full-screen mode on the CID, central information display, or the PID, passenger information display, might be used to adapt the display of images depending on the specific situation. For example, from an internet stream, the coordinator system might deduce the meta data that a soccer team has scored a goal, and a full-screen celebration of the team after the respective external trigger will then be shown. This allows for further product offerings and adds full-screen capabilities to the in-car experience. This applies as well to so-called pillar-to-pillar displays, i.e., unified displays for all at once.

Likewise, a full-screen animation might be used (on CID and PID), for example depending on the weather situation: There might be a full-screen animation of rainy weather be shown upon receiving an external trigger of projected rain. This allows for further product offerings and adds full-screen capabilities to the in-car experience.

Respective internal input means such as the input unit 12int in FIG. 5 might be provided with specific screens or slide shows as to the passenger occupant trigger, the weather, a sporting event, a time-based event, a location-based event, navigation, and the like. There might as well be provided information about the third party content and the platform availability. The user might be informed which and how triggers are defined (temporal, spatial, event-based, etc.), in a screen such as having the headline “My Triggers”, and likewise content to be delivered upon trigger activation might be defined on the screen having the headline “My Scenes”.

Third party platform content might be provided on multiple displays, and a preview of the vehicle interior might be given on a screen of the input unit 12int, or the like, together with respective information.

Specific software such as Azure®, Recombee®, and Algolia® might be used to personalize recommendations provided in such manner.

In a first embodiment, a platform application (such as an iOS app) might be used to get a recommendation for the logged-in user by using the existing API call. A personalizer is then asked by the recommendation service, i.e. a dedicated service, to provide N products from its catalogue, the personalizer returns the products ranked from the best to worst products to be recommended, the recommendation service then provides a platform application with a response containing the list of recommended products, leading to the app displaying these. The user's reaction for the recommended product or products might be measured and sent as reward value to the recommendation service, which then gives feedback to the personalizer.

In another embodiment, backend services (a store, purchase and activation) might themselves start to add new products or update/synchronize the products on file with the recommendation service, i.e. a dedicated service, or else might request a reset of all data and ask to send all products with a completely new attribute set. In response thereto, the recommendation system asks the software engine to send product attributes which are expected from products, the recommendation service itself sends product values which are simply products itself to add into the catalogue with the engine, the backend services thereafter send user interactions, such as purchases, views, cart additions, bookmarks, likes, or other weightings, and then, the recommendation service sends the coming interactions by enriching it with business logic to the software engine. The backend services further sent context such as a detail view, a homepage etc. for the recommendations. The recommendations service sends a preferred request by exploiting the coming context data from front and in order to get best matching recommendations to the software engine, that then returns recommendations with products attributes to the recommendation service, and the latter returns recommendations to the backend services.

In a third example, there might be offline calls and on real-time calls.

Within offline calls, new products or an update/synchronizing of the products might be added by backend services and such information sent to the recommendation service. Alternatively, a request to reset all data and to send all products with a completely new attribute set is requested. The recommendation service then sends the coming request by enriching it with business logic (if necessary) to the software engine, that collects response coming from the software service in order to track the updated/inserted products and sends the information to the recommendation service. The recommendation service returns to the backend service the information about the backend services about the update/insert task sent to the software engine.

As to real-time calls, an event register for a recommendation feedback takes place:

It starts with an application/iOS app for each user action on the product creating an event. For example, upon a click: A product is clicked, with a view, a product detail page is viewed, and conversion leads to a product being purchased. This information is provided to the recommendation service which then sends these events to the software engine, and they will be used in order to provide feedback to the recommendation service. The software engine responds back with confirmation in the event registry.

To summarize the embodiments briefly, information about the platform content (meta data) and information about customer behavior is sent to a third party algorithm and recommendations are received and used to personalize content on the platform user interface (i.e. an iOS app or the in-vehicle displays).

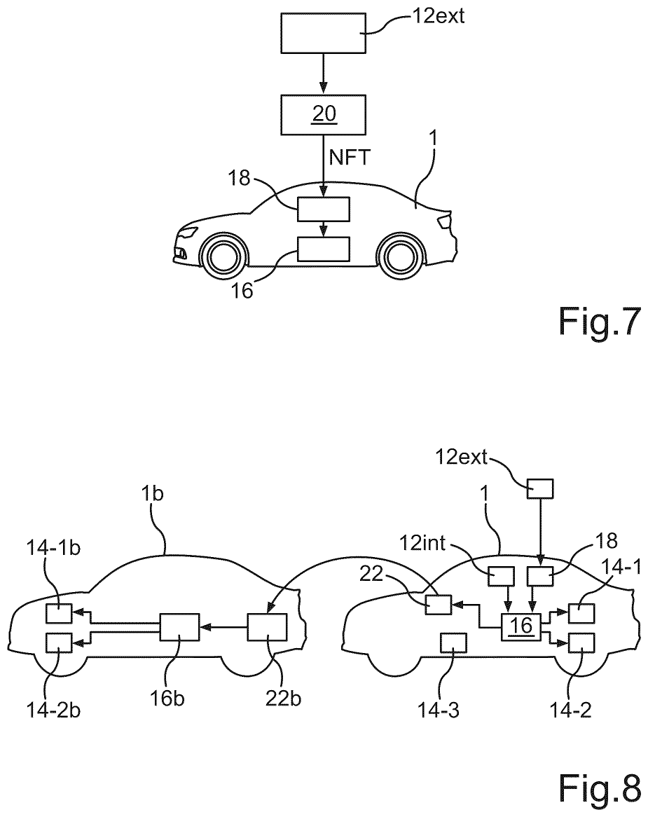

Turning now to FIG. 7, the following is to be noted:

As a follow-up of the example of FIG. 6, the external input unit 12ext starts in this specific embodiment with the idea to configure the unit to generate a unique signature for each created content, wherein the vehicle is configured to verify the respective signature and customize the vehicle functions only by content having the verified signature. Hence, the coordinator system will check whether such unique signature is present and correctly verified. The signature can preferably also be used to trace the content back to the external input unit 12ext. The unique signature is preferably protected, i.e. the signature may be encrypted and/or fraud resistant. For example, the signature can contain a cryptographic hash, preferably generated by a blockchain method. The advantage of this embodiment is that the origin of each content can be traced back what enhances the security of the vehicle. Furthermore, it can be ensured that only the improved external input unit 12ext is used to provide content to the coordinator system. This point is presently elaborated to the use of such verified signatures, namely to relate to the identity of the creator and owner of the underlying asset. This is for instance the case for non-fungible tokens (NFTs). In the embodiment of FIG. 7, these NFTs are added by unit 20. Thus, only individuals owning the content stored on/referenced by blockchain, are permitted to trade this content on the platform (specifically with the coordinator system) previously described, and subsequently used/displayed such content within devices participating in this system/platform, such as vehicles. Content relevant to NFTs not only includes third party images (artwork), but also meaningful representations of vehicle and part conditions. Explicitly, remanufactured parts (or vehicles), and used vehicles more broadly, may have digital certificates that record physical attributes, compatibility, and wear and/or performance data on the blockchain to provide prospective buyers with necessary information, and such information may be used to select content to display on the platform described herein, and the platform may have the ability to transfer ownership of underlying assets via smart contracts that underpin NFTs upon payment of agreed-upon fees.

The present system/platform shall further in an embodiment contain the ability for participants to summarize owned or desired products and/or services, using graphical or textual data. They may be able to share such information with other prospective customers. Such information may generate passive interest in the content being shared or be used to drive further commercial transactions. In the case of the latter, affiliate fees may be earned by the entity sharing such information.

FIG. 8 depicts a first vehicle 1 of a kind combining features explained with respect to FIG. 5 and with respect to FIG. 6. The coordinator system 16 may be coupled to a transceiver 22. The coordinator system may be able to describe in predetermined language (such as a natural language, English, German, French, and the like), or even in an artificial language, such as with a code, which actuators 14-1, 14-2 have been chosen in which situation. For instance, the actuators may simply be enumerated (1, 2, . . . N; N being the total number of actuators), and to each actuator, there might be a degree of actuation defined (such as 5 degrees for an actuator blowing air, or such as 30 degrees for a temperature-defining actuator, and the like). The summary then might only combine the input data (“cool”) with the output data. An example would be a string:
[“cool”; “(1,3);(2,4),
   saying that if the input is “cool”, actuator 1 has the third degree and actuator 2 has the fourth degree, of possible respective actuator degrees.

Such information in the manner of the string defined above, is translated by the transceiver 12 from the vehicle 1 to a corresponding transceiver 22b in the vehicle 1b, wherein this is then received by a coordinator system 16b in the vehicle that might activate its respective actuators 14-1b, 14-2b in alike manner.

The above information might be standardized to fit to multiple different actuator configurations, e.g. with different vehicles of different car manufacturers. This might include the string being able to define, let's say, 800 actuators with one actuator having 50 degrees of control signal, whereas in a real vehicle, they are only 200 actuators having between 3 and 25 degrees. However, then, the coordinator system 16b may be able to translate the respective information stemming from vehicle 1 to the requirements of its own actuators.

Overall, the example shows how a multisided digital platform offering products and services is provided by the invention.

1-13. (canceled)

14. A method of operating a coordinator system for a vehicle, the coordinator system being coupled to multiple input devices and being able to receive data from each of the input devices, and the coordinator system being coupled to multiple actuators of the vehicle and being able to output control signals to each actuator, the method comprising:
receiving, by the coordinator system, via at least one input device, data that define a situation to be created by the actuators;
selecting, by the coordinator system, in reaction to the receipt of the data, at least one actuator; and
generating and outputting control signals to the selected at least one actuator.

15. The method of claim 14, wherein the data defining a situation to be created have the function of meta data that are received by the coordinator system together with content data, wherein the content data are able to be used to directly define control signals for one or more predetermined actuators, wherein the coordinator system outputs the control signals to the selected one or more actuators in a coordinated manner, in con-junction with outputting the control signals to the one or more predetermined actuators.

16. The method of claim 14, wherein the coordinator system generates and outputs two sequential different control signals for one of the at least one selected actuators, thereby creating a situation changing over time.

17. The method of claim 14, wherein the coordinator system receives the data by a single input device, selects at least two actuators and generates and outputs signals for the at least two selected actuators, thereby defining the situation as a scenery.

18. The method of claim 14, wherein the coordinator system receives the data by multiple input devices, the data defining together the situation to be created.

19. The method of claim 18, wherein the coordinator system selects at least two actuators and generates and outputs signals for the at least two actuators, thereby defining the situation as a scenery.

20. The method of claim 14, wherein the coordinator system receives data by an input device provided separately to the vehicle.

21. The method of claim 14, wherein the coordinator system receives data by at least one sensor of the vehicle.

22. The method of claim 14, wherein the coordinator system receives data by at least one input device of the vehicle via which a user of the vehicle is enabled to define situations.

23. A coordinator system that is able to be coupled to multiple input devices and to multiple actuators, the coordinator system configured to select at least one of the actuators, in reaction to the coordinator system receiving data that define a situation to be created by the actuators, and to generate and to output control signals to the at least one select-ed actuators, for creating the situation to be defined by the data.

24. A coordinator system of claim 23 including means to provide artificial intelligence.

25. A vehicle with multiple sensors and multiple actuators, and the coordinator system according to claim 23.

26. The vehicle of claim 25, further including at least one input device via which a user of the vehicle is enabled to define the situations.

27. The method of claim 15, wherein the coordinator system generates and outputs two sequential different control signals for one of the at least one selected actuators, thereby creating a situation changing over time.

28. The method of claim 15, wherein the coordinator system receives the data by a single input device, selects at least two actuators and generates and outputs signals for the at least two selected actuators, thereby defining the situation as a scenery.

29. The method of claim 16, wherein the coordinator system receives the data by a single input device, selects at least two actuators and generates and outputs signals for the at least two selected actuators, thereby defining the situation as a scenery.

30. The method of claim 15, wherein the coordinator system receives the data by multiple input devices, the data defining together the situation to be created.

31. The method of claim 16, wherein the coordinator system receives the data by multiple input devices, the data defining together the situation to be created.

32. The method of claim 15, wherein the coordinator system receives data by an input device provided separately to the vehicle.

33. The method of claim 16, wherein the coordinator system receives data by an input device provided separately to the vehicle.
